(19) United States
(12) Patent Application Publication
(10) Pub. No.: US 2008/0040453 A1
(43) Pub. Date: Feb. 14, 2008

(54) Method and apparatus for multimedia encoding, broadcast and storage

(75) Inventor: Guillaume Cohen, Palo Alto, CA (US)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: VEODIA, INC., Palo Alto, CA (US)

(21) Appl. No.: 11/825,496

(22) Filed: Jul. 6, 2007

Related U.S. Application Data
(60) Provisional application No. 60/837,313, filed on Aug. 11, 2006.

(51) Int. Cl. G06F 15/16

(52) U.S. Cl. 709/219

(57) ABSTRACT

A method and apparatus for generating encoded media data, comprising a controller for distributing encoded media data to third party users, wherein the encoded media data is encoded in response to a control signal generated by the controller in collaboration with a media source.

### CROSS-REFERENCE TO RELATED APPLICATIONS

The present invention claims benefit of U.S. provisional patent application Ser. No. 60/837,313, filed on Aug. 11, 2006, which is herein incorporated by reference.

### BACKGROUND OF THE INVENTION

1. Field of the Invention

The present invention relates generally to capturing, encoding, distributing and/or storing of multimedia information, e.g., image sequences, video media data, and/or audio media data.

2. Description of the Related Art

Electronic and computer advancements offer a vast selection of technologies for media data encoding and display. Different encoding devices produce media data having various encoding parameters. Examples of encoding devices include cameras, video recorders, media software on computers, mobile phone cameras and the like. In addition, there are various types of display devices that may vary from portable user devices to stationary user devices. Such user devices usually display media data using specific decoding techniques (e.g. using a coder of a specific type). Examples of such devices are laptop computers, desktop computers, cell phones, personal digital assistant (PDA), and the like.

Media data may be stored on a server, which allows the media data to be accessible from diverse locations and on diverse user devices. However, if the encoding process used to create the media data is incompatible with decoding techniques of a user device, then the media data may not properly display or, in many cases, may not display at all on such user device.

Therefore, there is a need for a method or apparatus that would dynamically adapt the encoding and/or distribution technique in response to the encoding and distribution environment.

### SUMMARY OF THE INVENTION

Embodiment of the present invention comprise a method and apparatus for generating encoded media data, comprising a controller for distributing encoded media data to third party users, wherein the encoded media data is encoded in response to a control signal generated by the controller in collaboration with a media source.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of one embodiment of a media generation and distribution system that operates in accordance with the present invention;

FIG. 2 is a flow diagram depicting an exemplary embodiment of a method for distributing encoded media data;

FIG. 3 is a flow diagram depicting an exemplary embodiment of a method further detailing the controller receiving requests for distributing encoded media data;

FIG. 4 is a flow diagram depicting an embodiment of a method for generating an encoding control signal and encoding media data accordingly;

FIG. 5 is a diagram depicting an embodiment of a method for encoding and distributing encoded media data;

FIG. 6 is a diagram depicting an embodiment of a method for a user at the media source to utilize an interface screen in accordance with the present invention;

FIG. 7 is an illustration of an exemplary media source interface screen which facilitates the media source's communications with a controller;

FIG. 8 is an illustration of an exemplary encoded media data editing interface screen which facilitates the media source's communications with a controller;

FIG. 9 is an illustration of an exemplary encoded media data library interface screen which facilitates the media source's communications with a controller;

FIG. 10 is an illustration of an exemplary portal interface screen which facilitates the media source's communications with a controller;

FIG. 11 is an illustration of an exemplary portal creation interface screen which facilitates the media source communications with a controller;

FIG. 12 is an illustration of an exemplary invoice interface screen which communicates with a controller;

FIG. 13 is a diagram depicting an embodiment of a method for a user to utilize an interface screen in accordance with the present invention;

FIG. 14 is an illustration of an exemplary user portal interface screen which facilitates the user communications with a controller;

FIG. 15 is a block diagram of one embodiment of a dropped packets handling system that operates in accordance with the present invention; and

FIG. 16 is a diagram depicting an embodiment of a method for handling dropped media data packet in accordance with the present invention.

### DETAILED DESCRIPTION

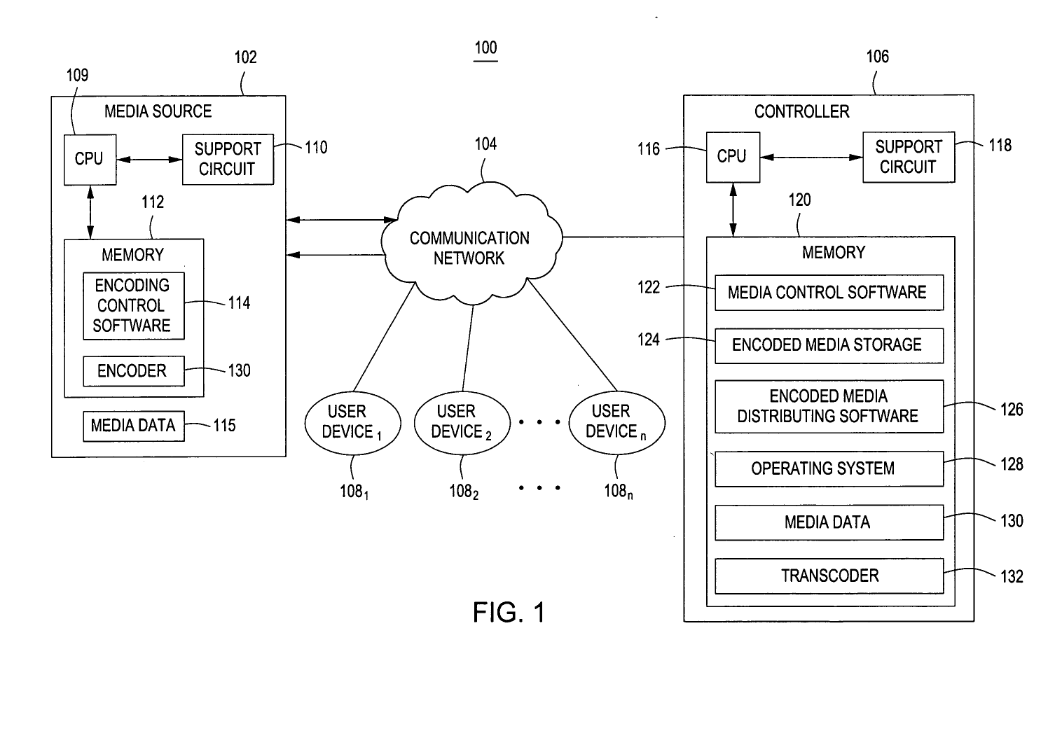

FIG. 1 is a block diagram of one embodiment of a media generation and distribution system 100 that operates in accordance with the present invention. This figure only portrays one variation of the myriad of possible system configurations. The present invention can function in a variety of computing environments; such as, a distributed computer system, a centralized computer system, a stand alone computer system, or the like. One skilled in the art will appreciate that the system 100 may or may not contain all the components listed below.

The media generation and distribution system 100 comprises at least one media source 102, at least one communication network 104, a controller 106, and one or more user devices 108₁, 108₂ . . . 108ₙ. The media source 102 is couple to the communication network 104. The controller 106 is coupled to the communication network 104 to allow media data produced by the media source 102 to be transmitted to the controller 106 and then distributed to the user devices 108₁, 108₂ . . . 108ₙ. Similarly, the user devices 108₁, 108₂ . . . 108ₙ are coupled to the communication network 104 in order to receive media data distributed by the controller 106. The communication link between the communication network 104 and the media source 102, the controller 106 or the user devices 108₁, 108₂ . . . 108ₙ may be a physical link, a wireless link, a combination there of, or the like. Media source 102 and the user devices 108₁, 108₂ . . . 108ₙ may be another computer system, a stand alone device, a wireless device, or the like.

The media source 102 produces end media data that the controller 106 distributes. The media source 102 may include, or may connect to, a media generating device, such as a camera, media data storage device, or the like. The media source 102 may comprise at least one central processing unit (CPU) 109, support circuits 110, and memory 112. In another embodiment, the media source 102 may not include memory 112; thus, the media source 102 would generate media data that the controller 106 would receive and distribute in real-time.

The CPU 109 may comprise one or more conventionally available microprocessors or microcontrollers. The CPU 109 may be an application specific integrated circuit (ASIC). The support circuits 110 are well known circuits used to promote functionality of the CPU 109. Such circuits include, but are not limited to, a cache, power supplies, clock circuits, input/output (I/O) circuits and the like. The memory 112 contained within the media source 106 may comprise random access memory, read only memory, removable disk memory, flash memory, and various combinations of these types of memory. The memory 112 is sometimes referred to as main memory and may, in part, be used as cache memory or buffer memory. The memory 112 generally stores the encoding control software 114 of the media source 102 and media data 115. The encoding software 114 may encode media data in accordance to the controller's 106 instructions. The encoding software 114 may also facilitate communications between the media source 102 and the controller 106.

The controller 106 may comprise at least one server. In another embodiment, the controller 106 may comprise multiple servers in one or different locations. The controller 106 may be remotely located from the media source; however, in some embodiments, some or all of the functions performed by the controller 106 as described below, may be included within and performed by the media source 102.

The controller 106 is generally shown and described as controlling the encoding process of the media source 102 and distributing the encoded media data to user devices 108. However, these two functions of the controller may be implemented on two distinct platforms, where one computer provides the encoding control function and a second computer provides the distribution function. The embodiments described throughout this disclosure and the term “controller” are intended to encompass this distributed implementation as well as single entity controller.

The controller 106 may comprise at least one central processing unit (CPU) 116, support circuits 118, and memory 120. The CPU 109 may comprise one or more conventionally available microprocessors or microcontrollers. The microprocessor may be an application specific integrated circuit (ASIC). The support circuits 118 are well known circuits used to promote functionality of the CPU 116. Such circuits include, but are not limited to, a cache, power supplies, clock circuits, input/output (I/O) circuits and the like. The memory 120 contained within the controller 106 may comprise random access memory, read only memory, removable disk memory, flash memory, and various combinations of these types of memory. The memory 120 is sometimes referred to as main memory and may, in part, be used as cache memory or buffer memory. The memory 112 may store an operating system 128, the media control software 122, the encoded media storage 124, encoded media distributing software 126, media data 130, and transcoder 132.

The media control software 122 analyzes the environmental characteristics of the system 100 to determine encoding requirements for producing media data that is optimally encoded for distribution. The analysis may include, but is not limited to, a review of connection bandwidth, media source requirements or requests, user device types, and the like. After the media control software 122 analyzes the environmental characteristics of the system 100, the state of the system 100 may be altered to accommodate the environmental characteristics. Accordingly, the media control software 122 re-analyzes the environmental characteristics of the system 100 and dynamically alters the encoding parameters for producing media data. Dynamic alteration of the encoding parameters may occur before or during encoding of the media data. For example, if the connection bandwidth changes during the encoding process, the controller acknowledges the bandwidth change and the media control software 122 re-analyzes the environmental characteristics of the system 100 to provide updated encoding parameters in response to the altered system characteristics.

In addition, in one embodiment of the invention, if multiple encoding types are requested by a system user, the media control software 122 sets the encoding requirements for one encoding type. The transcoder 132 within the controller 106 transcodes the received media data into other encoding types. For example, if a media source user specifies that the media data is to be encoded for a mobile device, a high definition device, and a personal computer, the media control software 122 may specify encoding parameters that are compatible with a high definition display. In the background, the transcoder 132 transcodes the high definition encoded media data to mobile device and personal computer display compatible media data. In another embodiment, the encoder 130 may simultaneously produce and transmit multiple encodings.

The encoded media storage 124 may archive encoded media data 130 for immediate or future distribution to user devices 108₁, 108₂ . . . 108ₙ. The encoded media distributing software 126 distributes encoded media data 130 to user devises 108₁, 108₂ . . . 108ₙ.

The memory 120 may also store an operating system 128 and media data 130. The operating system 128 may be one of a number of commercially available operating systems such as, but not limited to, SOLARIS from SUN Microsystems, Inc., AIX from IBM Inc., HP-UX from Hewlett Packard Corporation, LINUX from Red Hat Software, Windows 2000 from Microsoft Corporation, and the like.

In one embodiment, the system 100 may facilitate capturing and encoding live digital video using convenient mass-market consumer electronics devices, along with real-time network broadcast and storage via communication network 104. The media source 102 comprises a media encoder 130 (such as MPEG-4 SP/H.264 video compression) and may record live video as it is encoded. For example, the media source may be a video camera coupled to a personal computer (PC), where the video is encoded or transcoded using an encoder 130. Media data can also be distributed to the controller 106 from several types of media sources, including:

(a) a video camera connected to a computer enabled with a browser plug-in;

(b) a videoconferencing end-point, normally used for bidirectional communications; and

(c) a video camera fitted with an add-on module which enables video encoding and live media data delivery over a wireless network.

In one embodiment of the invention, the controller 106 rebroadcasts the live media, as it is received from a media source 102, over the communication network 104, or over another communication network, which facilitates communication between the user devices 108₁, 108₂ . . . 108ₙ and the controller 106. The controller 106 may distribute encoded media data to multiple user devices 108₁, 108₂ . . . 108ₙ, and may also simultaneously store a digital file of the encoded media data for later distribution on-demand to user devices 108₁, 108₂ . . . 108ₙ. The media source 102 may include, but is not limited to, cameras, mobile phones, camcorders, laptops, personal digital assistance (PDA), and the like.

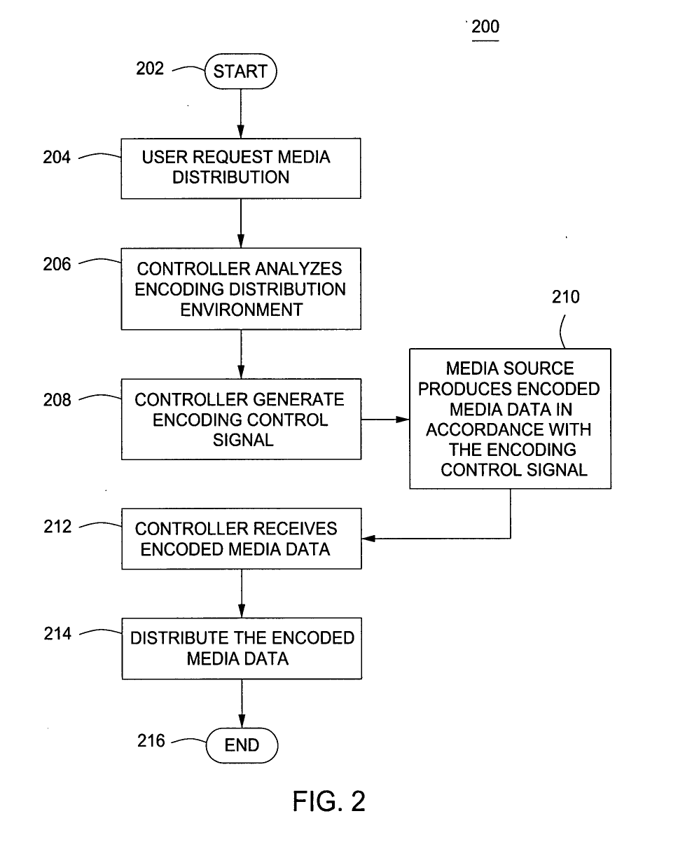

FIG. 2 is a flow diagram depicting an exemplary embodiment of a method 200 for distributing encoded media data. The method 200 starts at step 202 and proceeds to step 204, wherein a user at a media source requests that a controller receive encoded media data. At step 206, the controller analyzes the encoding and distribution environment of the system (i.e., environmental characteristics, media source capabilities, user device capabilities, network characteristics, etc). At step 208, after performing the analysis, the controller generates encoding control signal. At step 210, the media source produces encoded media data in accordance with the encoding control signal. At step 212, the controller receives the encoded media data from the media source with encoding defined by the encoding control signal generated by the controller. At step 214, the controller distributes the encoded media data to at least one network. The method 200 ends at step 216. In this manner, the controller may exploit collaborative information sharing between the media source and the user devices and adapts the encoding of the media source in order to optimize these processes.

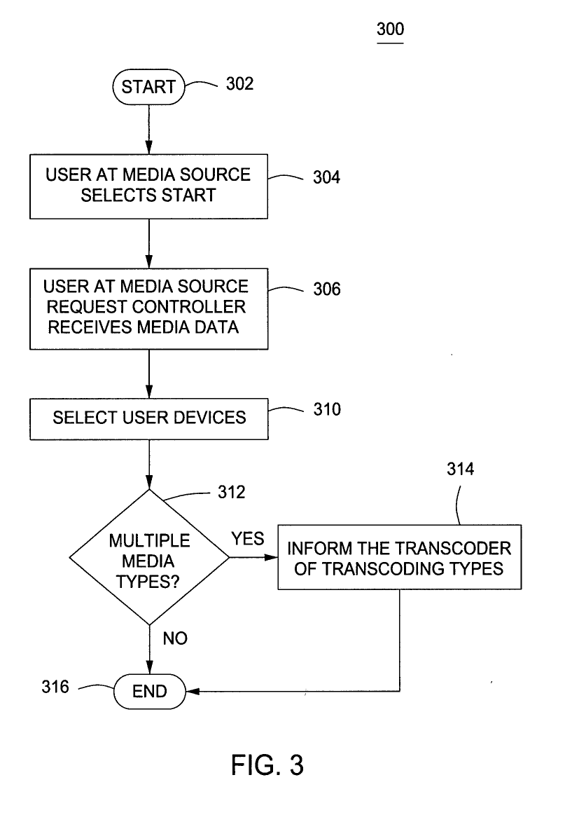

FIG. 3 is a flow diagram depicting an exemplary embodiment of a method 300 further detailing step 204 of method 200, in which the controller receives a request for distributing encoded media data. The method 300 starts at step 302 and proceeds to step 304, wherein a user at the media source selects START. At step 306, the user at the media source requests the controller receive media data. At step 310, the user at the media source selects the user devices or selected user device types (e.g. mobile device users). If no specific device type is selected, a default type is used, i.e., mobile, high definition, or the like. At step 312, the method 300 queries if the media data is to be encoded in multiple media encoding types. If multiple encoding types is selected by the user, the method 300 proceeds to step 314. At step 314, the transcoder is informed of the media data types to transcode the received encoded media data. From step 314, the method 300 proceeds to step 316. If only one media type is to be encoded (i.e., default selection), the method 300 proceeds from step 312 to step 316. The method 300 ends at step 316. It should be noted that, in another embodiment, a user device may request encoding parameters and initiate the controller's encoding process, such that the encoded date complies with the constraints of the user device.

For example, the controller may feed back to the media source information about the communication network link between the media source and the controller (such as effective network bandwidth), CPU usage of the media source computer, and/or constraints of the playback device, and the encoder within the media source uses such information to automatically determine optimal encoding parameters (such as frame rate, bit rate, resolution, and the like). Alternatively, the controller might determine suggested encoding parameters based on the environment and provide those suggested parameters to the encoder. The user may choose to use or not use the suggested parameters. Either way, the media source preferably alters and enhances its encoding behavior based on this collaborative exchange of such information. As a further example, the controller may notify the media source 102, in real-time, of any dropped media data packets. Responsive to this notification, the media source selectively stores such lost data packets, and resends them to the controller later for purposes of reconstituting an accurate storage copy of the media data. (The term ‘accurate’ means a more complete copy of the original; it may not be necessary in all embodiments to reconstitute 100% of all original data.)

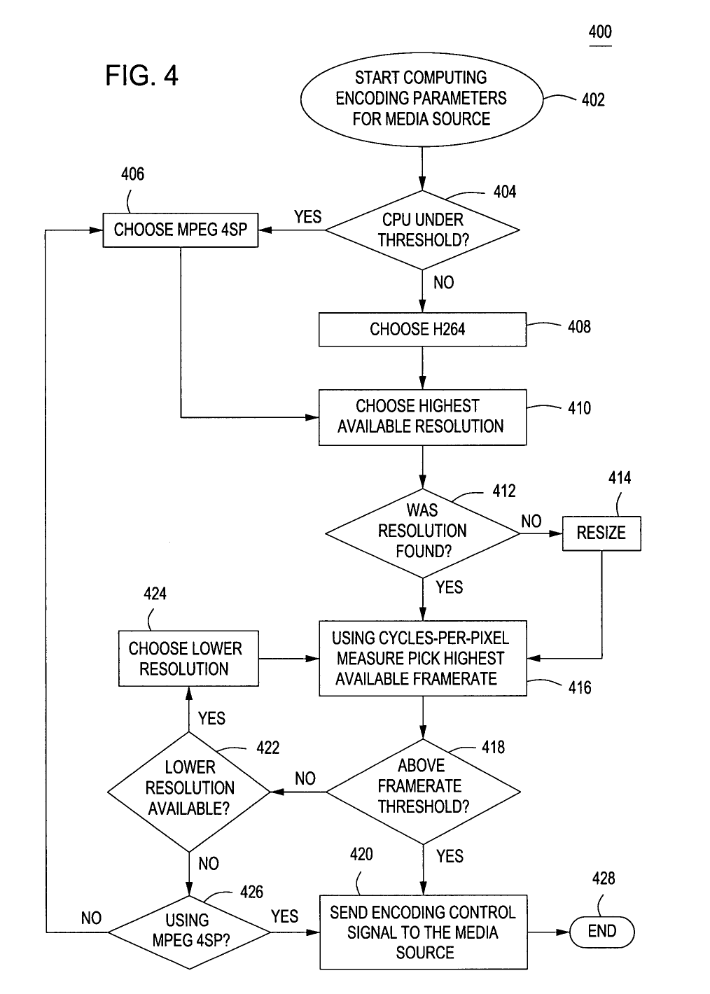

FIG. 4 is a flow diagram depicting an exemplary embodiment of a method 400 further detailing steps 206 and 208 of method 200, in which the controller generates an encoding control signal used for encoding data. The method 400 starts at step 402, wherein the controller starts computing encoding parameters for the media source. The method 400 proceeds to step 404. At step 404, if the CPU of the media source and is operating below a predetermined processing cycle threshold (i.e. the CPU is being underutilized) the method 400 continues to step 406. At step 406, the controller chooses MPEG-4 SP, for example, as a parameter for the encoding control signal. If the CPU is not below the predetermined threshold, the controller continues to step 408, wherein the controller chooses H.264, for example, as a parameter for the encoding control signal. From step 404, the method continues to step 410. A step 410, the controller may choose the highest available resolution. At step 412, if the resolution is not available, the method 400 continues to step 414. At step 414, the controller resizes the image to facilitate a high resolution.

From steps 412 and 414, the method 400 continues to step 416. At step 416, the control may use the cycles-per-pixel measure (discussed in detail below) and may pick the highest available frame rate. At step 418, if the setting is not above the frame rate threshold, the method 400 continues to step 422. At step 422, if the lower threshold resolution is available, the method 400 continues to step 424. At step 424, the controller may choose a lower resolution and the method 400 repeats steps 416 and 418. At step 422, if the lower resolution is not available, the method 400 proceeds to step 426. At step 426, if the setting is not for MPEG-4 SP, the method 400 returns to step 406. At step 406, the method 400 continues to step 410. If the setting is for MPEG-4 SP, the method 400 proceeds from step 426 to step 420. Similarly, at step 418, if the setting is above frame rate threshold, the method 400 proceeds to step 420. At step 420, the controller sends an encoding control signal, which includes the suitable encoding parameters, to the media source. The method 400 ends at step 428.

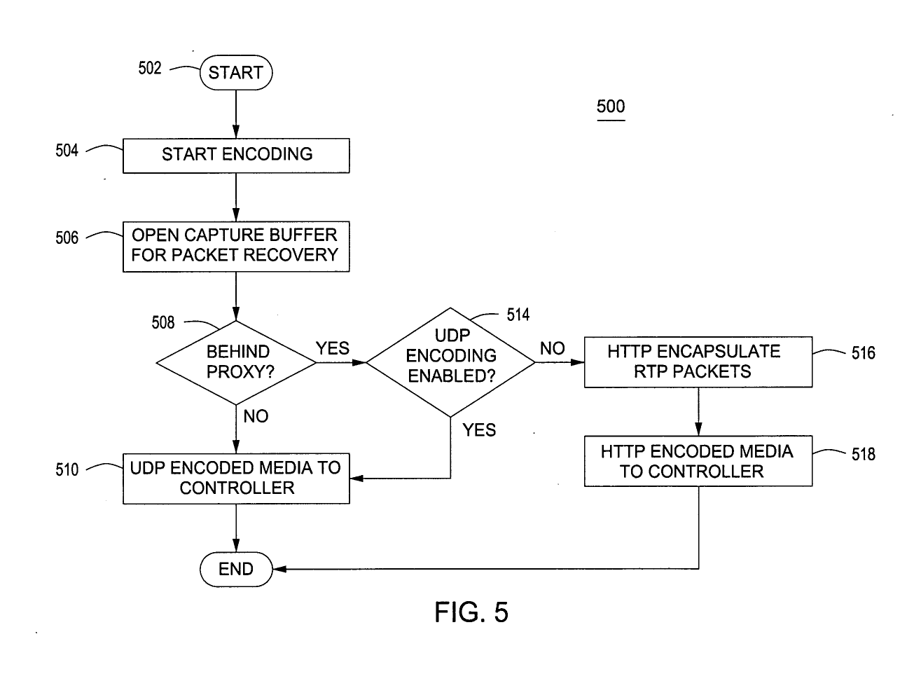

FIG. 5 is a flow diagram depicting an exemplary embodiment of a method 500 further detailing step 210, of method 200, which relate to encoding, media data. Method 500 starts at step 502 and proceeds to step 504, wherein the media source starts encoding media data in accordance with the control signal. At step 506, the media source may open a capture buffer for packet recovery. At step 508, if the media source is behind a proxy, the method 500 proceeds to step 514. If the media source is not behind a proxy, the method 500 proceeds to step 510. At step 514, if the UDP transmission is enabled, the method 500 proceeds to step 510, wherein the UDP encoded media data is sent to the controller. If the UDP transmission is not enabled, the method 500 continues to step 516, wherein the media source encapsulates the media data packets with HTTP encapsulation. At step 518, the HTTP encapsulated media data packets are sent to the controller. If the media source is not behind proxy at step 508, the method 500 proceeds from step 508 to step 510, wherein the UDP encoded media data is sent to the controller. The method 500 ends at step 520.

In one embodiment, the controller adapts the encoding process to fit the distribution environment. Such an environment can be is characterized by:
S=Upstream speed of the network connection between the media source and the controller (dynamic value)
P=CPU power available for encoding (dynamic value)
R=set of resolutions supported by the capture device
D=playback compatibility requirements (e.g. target device codecs or resolutions limitations)

And the encoding parameters that are determined for an optimized transmission are:
C=Codecs for video and audio. The codecs can be characterized by their compression efficiency (quality/bitrate) and their encoding complexity (CPU cycles required per encoded pixel)
F=Framerate and audio sampling frequency
B=Bitrate
Re=Encoding Resolution

For example, a user wishing to produce media data is only required to press a button to start an encoder, and the encoding settings are automatically set based on the hardware and the network environment. In this way, the user will have the best visual quality possible given the environment without knowledge of the encoding settings.

If F is the function to determine the encoding parameters given the environment at time t:

(C,F,B,Re)=F(S,P,R,D)(t)

F is a function of the environment (CPU power, network uplink speed, etc) and of the time t since CPU resources and the network environment change dynamically.

F can be computed deterministically or through a cost function with statistic models and Monte Carlo analysis.

Periodically, the controller uses the function F to calculate the optimal set of encoding settings given the environment at time t and a command is sent to the encoder to adjust its encoding parameters while still encoding the live media. This allows the encoding bitrate curve to follow the dynamic bandwidth capacity of the network link to avoid rate distortions.

Below is an example of logic that can be used to compute F(t) and determine the best set (C,F,B,Re).

In general, the main constraint to optimal transmission is the upstream speed of the network link between the media source and the controller. This upstream speed provides a maximum limit to the bitrate that is used to distribute the live multimedia content. To account for overhead and variance of the bitrate, the overall bitrate (video+audio) may be set at a percentage of the measured available bandwidth (for example 80% of the measured available bandwidth). For a more accurate measure, this percentage may be set based on a measured or predicted statistical distribution of the upstream speed. Once the bitrate is chosen, the algorithm may choose a corresponding set of resolution, framerate, and codec that will provide good quality media data.

For a given codec, empirical measures enable the determination of the general characteristics of any particular codec: Bitrate per pixel needed for good frame visual quality (for example with no visible artifacts), and CPU cycles per pixel needed to encode media in real time. This value measures the performance of the encoder in terms of encoding complexity.

The CPU cycle cost required to perform resizing of the video can also be taken into account in the optimization calculation (in particular when it is necessary to encode at a lower resolution than the native resolution of the capture device for a better visual quality vs. resolution).

The controller measures the available CPU power of the media source and uses the information as a metric for optimizing the encoding process. This imposes an additional constraint on F(t): the encoding parameters should be chosen such that the number of CPU cycles required to encode the media is within the capabilities of the encoding machine. Failure to do so would exceed the CPU usage limit of the encoding device and result in lost frames and non-optimal quality of the encoded media data.

As an example, suppose there are two codecs available in the media source: H.264 and MPEG-4 SP:
1) H.264 is more efficient in terms of quality vs. bitrate but its encoding complexity is higher (requires more CPU cycles to be utilized to encode video).
2) MPEG-4 SP is less efficient in terms of quality vs. bitrate but it is less complex (requires less CPU cycles to be utilized to encode video).

Although H.264 is generally considered a better codec, in the sense that it is more efficient for quality vs. bit rate, it will be better to use MPEG-4 SP in some cases. For example, if the media source has a very low CPU power but the storage of the controller has high capacity, MPEG-4 SP may be preferred.

Additional constraints can be utilized to computate F(t), in particular if the target playback device (user device) only supports a few specific resolutions or codecs, such information should be used to optimize F(t).

Each codec (H.264, MPEG-4 SP) has a different computational cost, the assumption used to optimize F(t) is that this cost is proportional to the size of a video frame in pixels.

CPU use by an encoding technique can be calculated using the following formula: F*P*R=C; where:

F=frames per second

P=Pixels per frame

R=Cycles per pixel

C=CPU cycles

### F, P, and C are measurable, such that using the following formula, R can be determined.

R=C/(F*P)

For example, the following data was gathered on a PC with CPU speed of 2791 MHz:

| Codec | width | height | Fps | bitrate | CPU % |
|---|---|---|---|---|---|
| H.264 | 320 | 240 | 1 | 200000 | 24 |
| | | | 2 | | 26 |
| | | | 4 | | 28 |
| | | | 8 | | 35 |
| | | | 15 | | 48 |
| | 176 | 144 | 1 | | 15 |
| | | | 2 | | 17 |
| | | | 4 | | 19 |
| | | | 8 | | 20 |
| | | | 15 | | 23 |
| MPEG-4 | 320 | 240 | 1 | | 20 |
| SP | | | | | |
| | | | 2 | | 22 |
| | | | 4 | | 23 |
| | | | 8 | | 25 |
| | | | 15 | | 32 |
| | 176 | 144 | 1 | | 10 |
| | | | 2 | | 11 |
| | | | 4 | | 13 |
| | | | 8 | | 15 |
| | | | 15 | | 16 |

Using the forgoing data to solve for R reveals the following:

R(H.264)=904

R(MPEG-4 SP)=578.5

Consequently, for this computer, H.264 encoding requires substantial more cycles per pixel to encode video when compared to encoding with MPEG-4 SP. This information can be used to optimize F(t).

In another embodiment of the invention, the controller may gather further data from its users about CPU consumption and system characteristics of different machines (both user devices and media source). User CPU data may be used to further refine the CPU consumption model, allowing for accurate prediction relating to CPU consumption on a wide variety of machines.

The foregoing described dynamically choosing the ideal encoding settings based on the hardware and network environment, however, in some cases, there may still be some packet losses in the transmission between the media source and the controller. Such packet losses cause a stored file to be missing data, and result in a permanently degraded quality of the stored file. This is particularly a problem since the purpose of storing the file is to host and serve the file on-demand for future viewers.

To address this issue, the controller may implement step 506 at FIG. 5 by utilizing a Real-time Transport Protocol (RTP) to transfer media data from the media source to the controller. Because RTP data packets are numbered, it is easy for the controller to identify which packets, if any, have been lost during the storage (or RTP capture) process. Every time the controller detects that a packet was not received in time, the controller instructs the media source to save the lost packet for later transmission. A sliding window buffer implemented within the memory of the media source maintains RTP packets for an amount of time sufficient to determine whether such packets were received or lost. Once the status of a particular packet is known, the packet is either saved for later transmission or, if transmission was successful, discarded from the buffer. The media source accumulates all the lost packets during the entire encoding and transmission process.

During or at the end of the live broadcast, the media source sends all the lost packets stored in the buffer to the controller which reconstitutes the file. The lost packets may not be retransmitted in time for (or used in) real-time rendering during the live broadcast, since the goal is reconstitute a storage copy. Because of the rate adaptation that was described above, the packet losses would be minimized. Therefore, the set of all lost packets (A) that are sent to the controller would be small, minimizing the transfer time and assuring that the final stored file is available immediately after the end of the broadcast.

A=(total set of RTP packets sent by the media source)−(set of RTP packets received by the controller)

Note that this “post encoding packet recovery” method potentially allows the system 100 (FIG. 1) to encode at a higher bitrate than the capacity of the network, while producing an accurate file on the remotely located controller 106. Compared to the case where the bitrate is adapted to the network capacity, this technique would increase the size of A and therefore the size of temporary storage space needed in the media source side to store the lost packets, and also it would delay the availability of the final stored file on the controller since more time will be required to transfer A. But this could also be used as a method to perform high quality encodings while significantly reducing the time needed to make the file available on the controller for on-demand delivery.

The general technique of encoding using media source and storing on a single server of the controller can be extended to simultaneously store files on multiple servers (for example on multiple nodes of a content delivery network (CDN)) in order to have a media file ready to be served on multiple edge servers immediately after the end of a live broadcast. A master or primary server is selected from among the plurality of servers and assigned to a particular media source based on performance factors such as network proximity and load balancing. Each recipient of the broadcast (or on-demand transmissions) can be assigned to receive video from a server selected from among the plurality of servers based on similar criteria. All servers may store media data received from the same master server, who reflects copies of the original media data to the secondary recording servers. The master server may also perform the initial packet recovery and the encoder feedback control. Secondary storage servers can then communicate directly with the master server to retrieve the RTP packets they didn't receive during live media data distribution.

The system 100 (FIG. 1) generally includes a user interface (“UI”) for the controller 106 that allows users to schedule or start spontaneous live video broadcasts, manage and edit recorded videos into their private library, append videos and publish live and recorded content onto public portals for an external internet audience, all without requiring detailed knowledge about video.

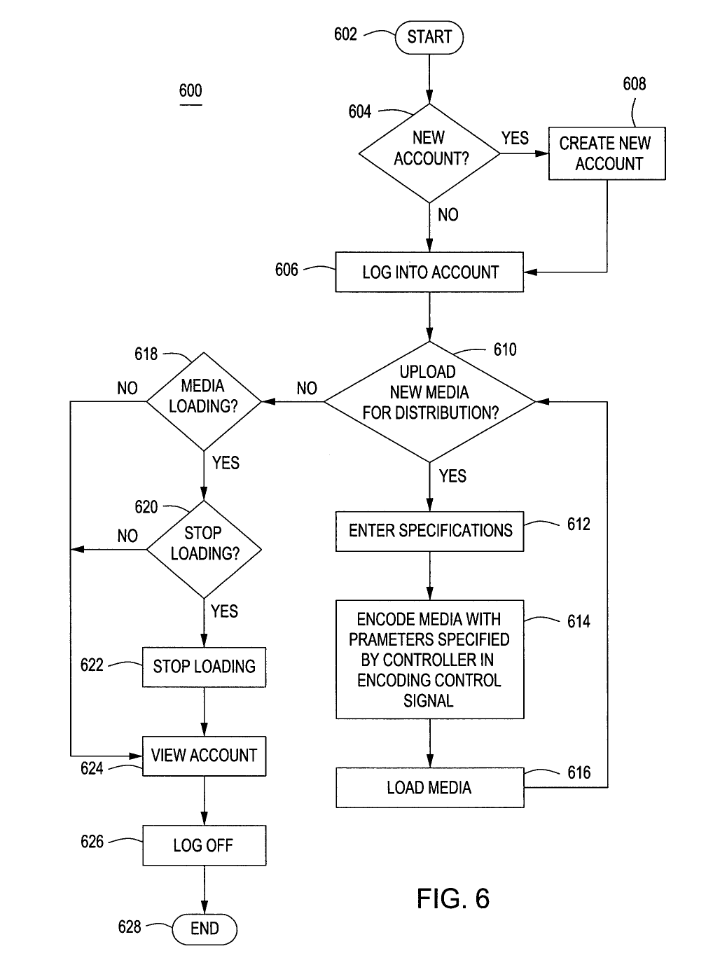

FIG. 6 is a flow diagram depicting an exemplary embodiment of a method 600 for a user at the media source to utilize a user interface in accordance with the present invention. The method 600 starts at step 602 and continues to step 604, wherein the user at the media source does not have an existing account, the method 600 continues to step 608, wherein the user at the media source creates a new account. At step 608, the method 600 proceeds to step 606. If the user at the media source has an account, the method 600 proceeds to step 606. At step 606, the user at the media source logs onto the relevant account. If the user at the media source chooses to upload new media for distribution, the method 600 proceeds to step 612. At step 612, the user at the media source enters the encoding specifications (e.g. ancillary data/description) for the media data to be distributed by the controller. As discussed above, the controller computes encoding parameters for the control signal.

At step 614, the media source receives an encoding control signal and encodes media data accordingly. At step 616, the user at the media source loads the encoded media data onto the controller, such that the controller can distribute and/or store the media data. From step 616, the method 600 returns to step 610. At step 610, if the user at the media source does not intend to distribute new media, the method 600 proceeds to step 618.

At step 618, if the media is in the process of loading (distributing), then the method 600 proceeds to step 620. At step 620, if the user at the media source wishes to stop the media loading, the method 600 proceeds to step 622. At step 622, the user at the media source stops the media loading. From step 622, the method 600 proceeds to step 624. If the user at the media source is not loading media data or does not wish to stop a loading of data, then the method 600 proceeds from steps 618 and 620 to step 624. At step 624, the user at the media source may view the relevant account. At step 626, the user at the media source may choose to log off. The method 600 ends at step 628.

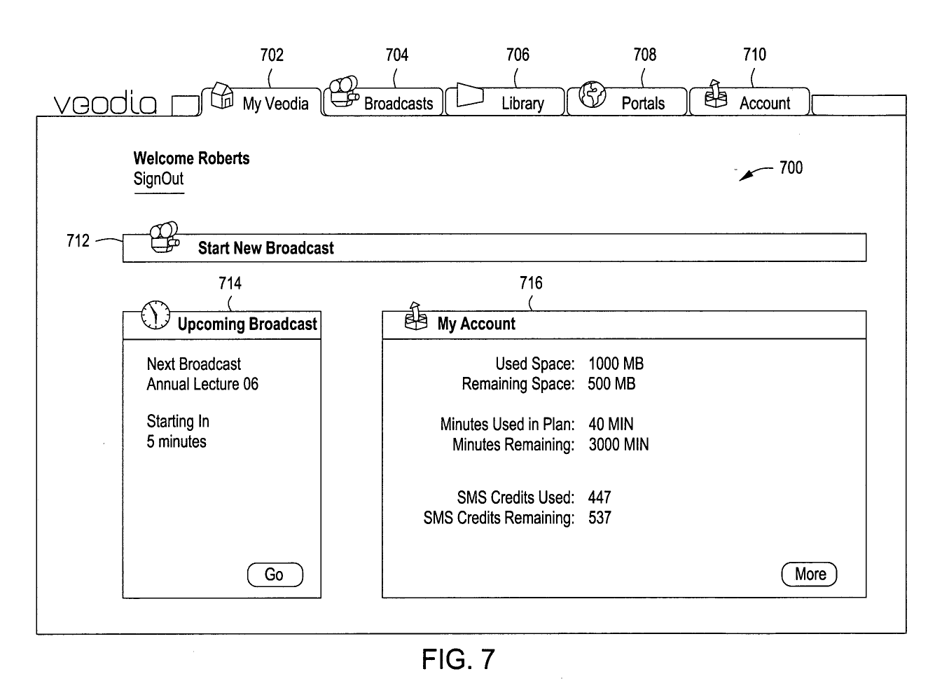

FIG. 7 is an illustration of an exemplary media source interface screen 700, which facilitates the media source's communications with a controller. The media source interface screen 700 may contain personal account information, such as the “My Veodia” tab 702. The media source interface screen 700 may also include tabs, such as, “Broadcast” tab 704, “Library” tab 706, “Portals” tab 708, and “Account” tab 710. The media source interface screen 700 may also include a “Start New Broadcast” section 712, which allows a user at the media source to start distribution of encoded media data. A user at the media source may also view scheduled future distributions in section 714 or account information in section 716.

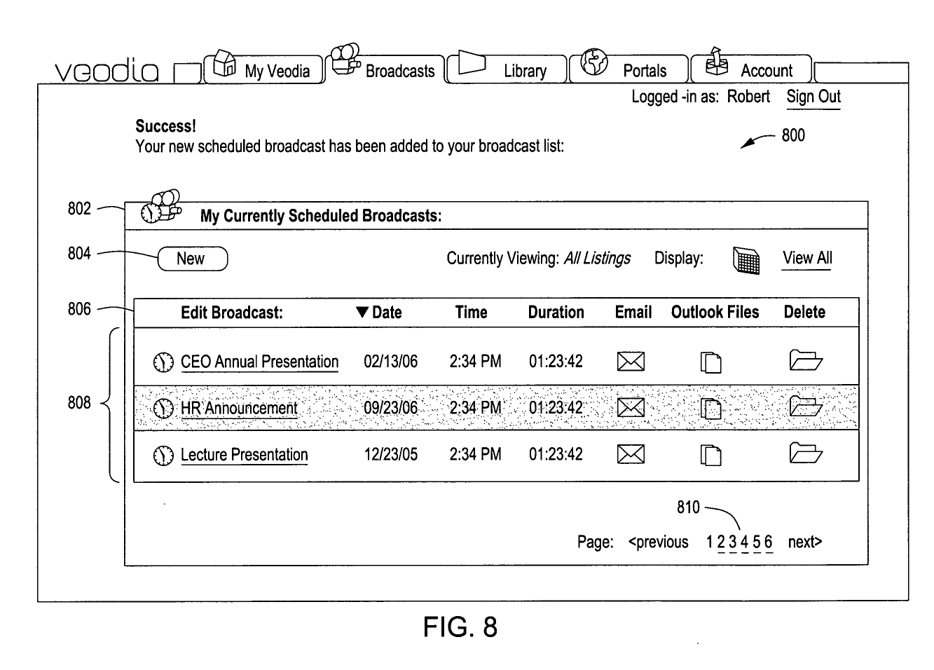

FIG. 8 is an illustration of an exemplary encoded media data editing interface screen 800, which facilitates the media source's communications with the controller. Selecting the “Broadcast” tab 704 may display the encoded media data editing screen 800, wherein the media data can be altered or appended. The encoded media data editing screen 800 may include a scheduled broadcast section 802. The scheduled broadcast section 802 may include a “New” button 804, which would allow the user at the media source to create new broadcasts, and an edit screen 806, which would include broadcast list 808. The encoded media data screen 800 may also contain a page selection section 810, which allows the user at the media source to store and view broadcasts on multiple screen pages. In one embodiment, the user may schedule broadcasts and designate a price for viewing such broadcasts. Thus, the broadcast list 808 may indicate a time of broadcasting, duration of the broadcast, and the price to view such broadcast.

At the end of the broadcast, the user presses the stop button. While the broadcast was taking place, it was simultaneously being recorded on the remote server, and after the stop button is pressed, only the differential “delta” of any lost packets needs to be transmitted after recording in order to reconstruct a perfect recorded copy at the server for storage: all in accordance with the present invention described above. Due to this approach, the recording is available on the server and ready to serve on-demand a few seconds after the stop button is pressed, regardless of the duration of the broadcast. Such recordings can interactively be made available for on-demand viewing through the “Library” section of the UI described below.

It is also possible to interactively view and edit scheduled broadcasts. The scheduling function allows users to: make sure resources will be available at the time of the broadcast; have the broadcast announced on private portals or a program guide; and send information about the broadcast in advance.

Alternatively to creating broadcasts from a camera connected to a computer, it is also possible to broadcast from a Videoconferencing end-point. When this option is chosen, the user interface will provide an IP address (or H.323 alias) to contact to initiate the broadcast and recordings.

Users can go to the Broadcast section to either schedule live broadcasts or to immediately start a new live broadcast. For example, when choosing to start a live broadcast from their computer (equipped with a USB or DV camera), users are taken to a web-based “production” area. The first time they access this page, a plug-in is automatically installed and plugs to the Internet browser. This plug-in gives a video preview of the camera source and a start button to start the broadcast. When users press the start button, the plug-in communicates with an assigned server, and the user's local computer and the server collaborate to automatically determine the network link between the two and to select the best encoding settings given the current environment, in accordance with the automatic adaptive encoding methods described above. The encoding thus starts with optimal settings given the imposed environment. Furthermore, these settings are dynamically updated during the broadcast so that video encoding is always optimal quality with respect to the changing network and hardware environment. Due to this approach, the user only has to press start and does NOT have to manually adjust any encoding settings prior to beginning or during his broadcast.

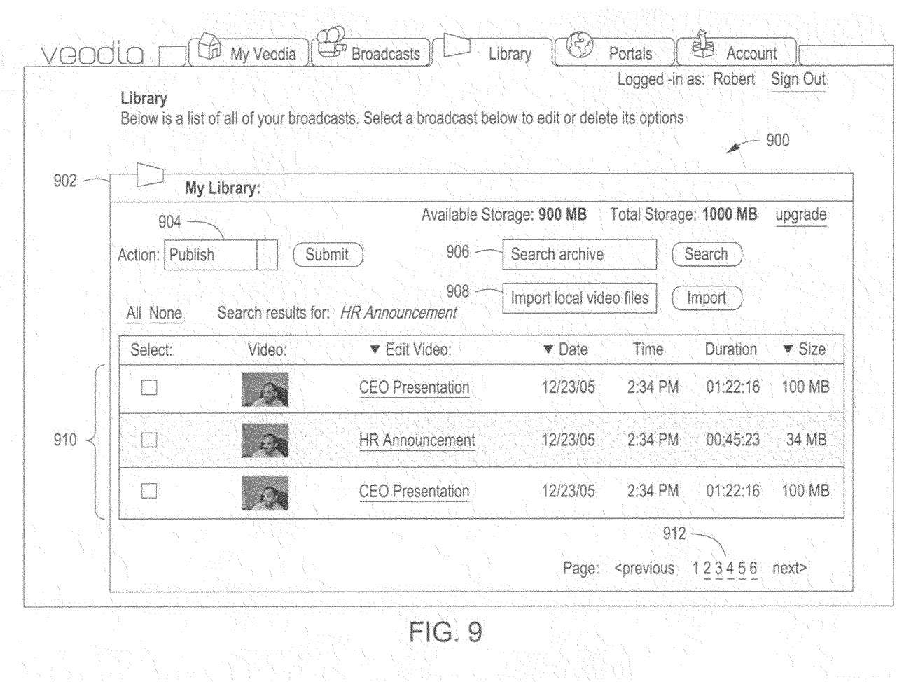

FIG. 9 is an illustration of an exemplary encoded media data library interface screen 900, which facilitates the media source's communications with a controller. Selecting the “Library” tab 706 may display the encoded media data library screen 900. The encoded media data library screen 900 may include the “My Library” section 902. The “My Library” section 902 may include an action section 904 for requesting from the controller to perform an action with respect to a specific media data contained in a media data list 910. The actions available include at least one editing the media data, appending media data to another media data, and the like

The Library section is where users go to manage their files privately. They can access a list of files and select them to perform actions such as: deleting some files; editing files, in particular their description, tags, or even the video itself (cut and paste); and to publish these files onto public portals. Publishing files onto a public portal makes them available to a public audience on computers, TVs, or even portable devices such as 3G phones and iPods.

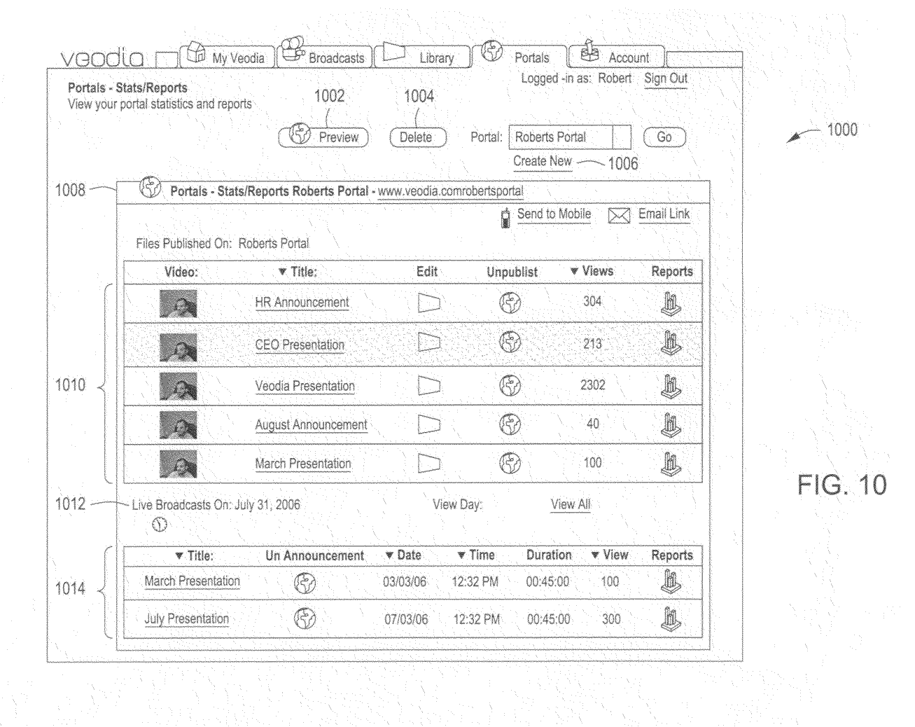

FIG. 10 is an illustration of an exemplary portal interface screen 1000, which facilitates the media source's communications with a controller. Selecting the “Portals” tab 708 may display the portal interface screen 1000, which may include a “Preview” button 1002, for previewing media data, or a “Delete” button 1004 for deleting encoded media data. The portal interface screen 1000 may also include a portal status and report section 1008, which may include a video list 1010, live broadcast information section 1012 and future distribution of encoded media data list 1014. The video broadcast list information section 1012 may include video information, such as, titles, views, reports, and the like. The future distribution of encoded media data list 1014 may include distribution information, such as, titles, distribution date and times, views, reports, and the like.

In this section, it is also possible to customize the options of the portal, for example: to upload a logo, to protect the portal for restricted access, to change the display options, etc.

The Portals section allows users to select one of their existing portals or to create a new portal. Once a portal is created, users can preview the portal (to see it the way their audience will see it). They can also see the list of files and broadcasts published on this portal and perform the following actions for each item: remove them from the portal; preview the items; and access reports on who viewed the specific content, when, and how much they viewed.

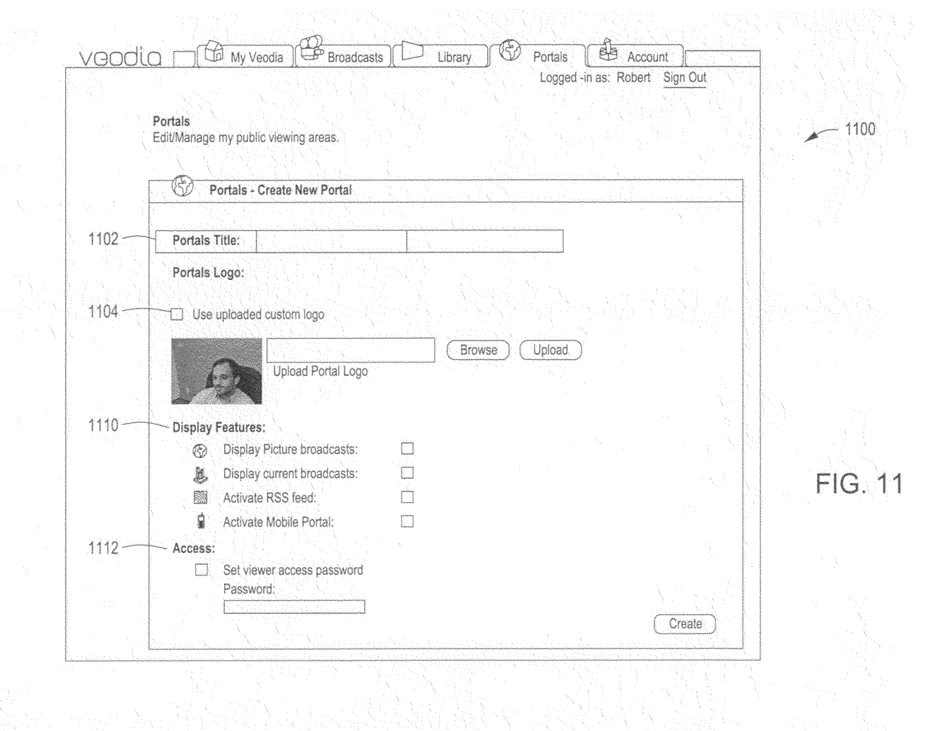

FIG. 11 is an illustration of an exemplary portal creation interface screen 1100, which facilitates the media source's communications with a controller. Selecting the “Portals” tab 708 may also display a portals creation interface screen 1100, which allows a user at the media source to enter portals information when creating a new portal. The portal information may include portal titles section 1102, logo section 1104, display features section 1110 and access section 1112. The logo section 1104 allows a user at the media source to upload a logo for a portal. The logo section 1104 may also include a “Browse” button, for browsing for a logo online or in memory and for an “Upload” button, for uploading a selected logo. The display features section 1110 allows a user at the media source to select the user devices that would display the encoded media data relating to the portal. Thus, a controller may analyze the encoding needed for such selected user devices and include relevant parameters in the encoding control signal. The access section 1112 allows a user at the media source to restrict the viewing of the encoded media by setting a password to the portal.

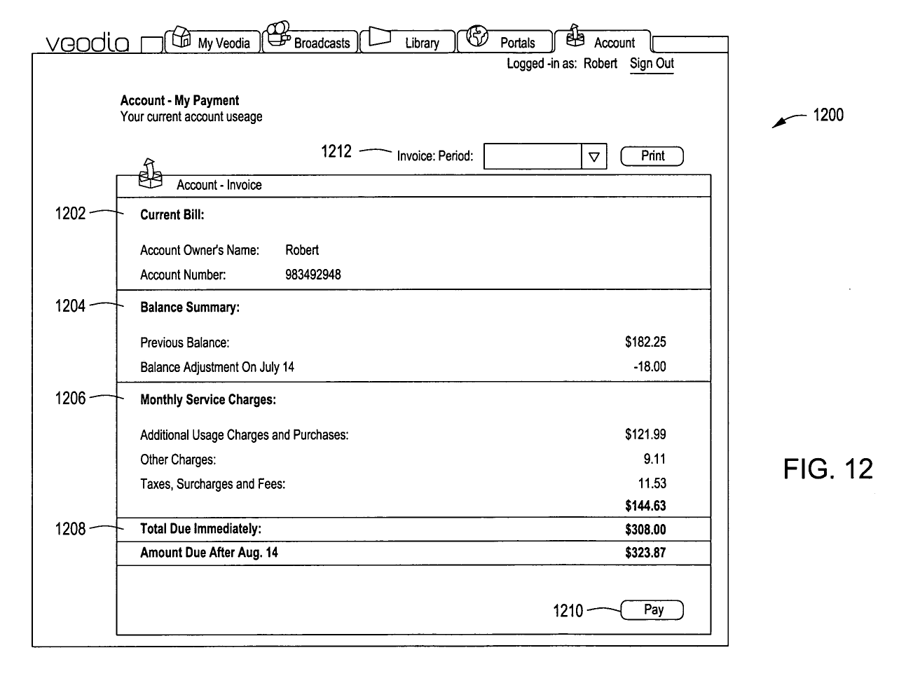

FIG. 12 is an illustration of an exemplary invoice interface screen 1200, which communicates with a controller. Selecting the “Account” tab 710 may display the invoice interface screen 1200, wherein a user at the media source is able to track the costs incurred by the media source's activity on the controller. The invoice interface screen 1200 may include a current bill section 1202, a balance section 1204, a monthly service charges section 1206, a total due section 1208, and the like. The invoice section screen 1200 may also allow a user at the media source to pay dues or bills by pressing a “pay” button 1210.

The account section allows users to: view and edit their personal information; check their account usage; view their payments or make a payment; view their invoices; view their plan details and upgrade to a different plan.

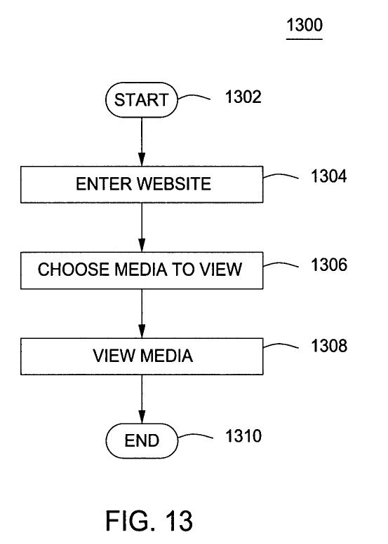

FIG. 13 is a diagram depicting an embodiment of a method 1300 for a user to utilize an interface screen to view stored or broadcast media data in accordance with the present invention. The method 1300 starts at step 1302 and proceeds to step 1304. At step 1304, the user enters website information (i.e. enter a URL) in a conventional browser to identify a server from which the media data is available. At step 1306, the user chooses the media to view. At step 1308, the user views the media on at least one user device as the media is streamed from the controller either as a live broadcast or from a stored file. The method 1300 ends at step 1310.

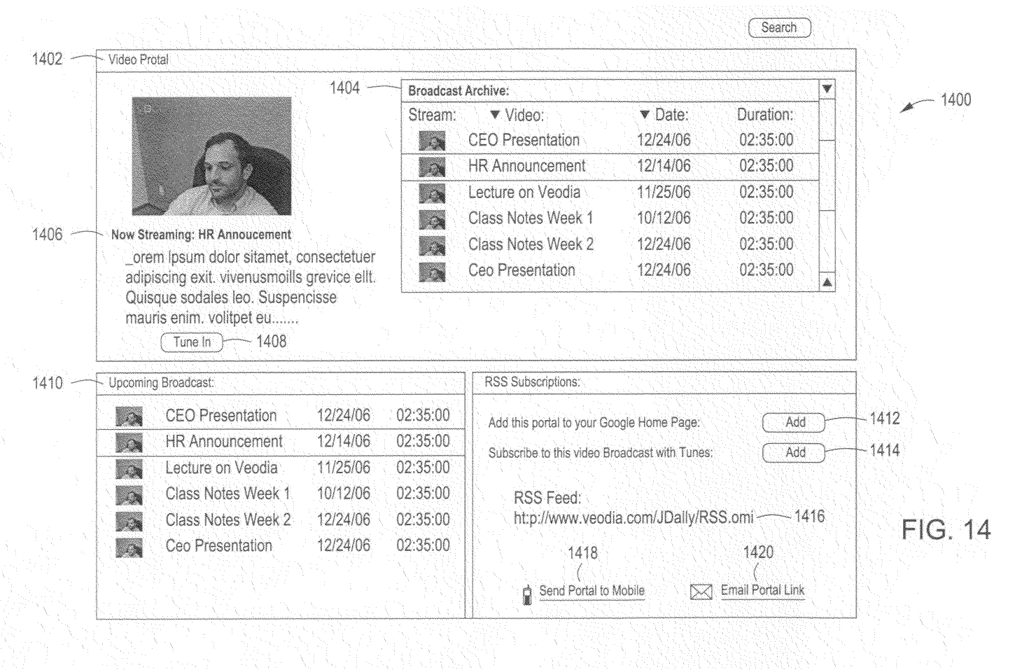

FIG. 14 is an illustration of an exemplary user portal interface screen 1400 which facilitates the user communications with a controller to select media to view. The user portal interface screen 1400 may include a virtual portal section 1402, which may include a streaming section 1406 and a broadcast archive section 1404. The streaming section 1406 would include real-time distributions and may allow a user to watch such distribution by pressing a “Tune in” button 1408. The broadcast archive section 1404 may include a list of encoded media data that the controller archived for a user to watch at a later time from the controller media data retrieval time. The user portal interface screen 1400 would also allow a forecast future distribution in an upcoming broadcasts section 1410, which may include a list of encoded media data to be distributed at a later date.

Audience members (users) who wish to view live broadcast or on-demand video content that is made available through the present invention can use a standard Internet browser to visit the publisher/user's portal page, and then simply click on links to begin viewing of selected content via browser and media player. A mobile version of the portal (adapted to mobile phones browser and media player capabilities) is automatically served when such a device requests the portal. Similarly, when accessed by a set-top-box (for playback on a TV screen), a special version of the web-based portal is served to the set-top-box allowing program navigation via a remote control. The portal offers other features such as the ability to send its URL to other viewers on computers and mobile devices via email and text message. Finally, users can also subscribe to RSS feeds on the portal, for automatic delivery of future postings (and/or for notification thereof) e.g. via RSS feeds or podcast. Viewers may also enter their email address and/or phone number for automatic notification and delivery of newly published content via email (on computers) or SMS (on mobile phone). Audience members accessing a publisher's portal can also interactively search for currently available (or upcoming) video content of interest, for example by entering keywords matched by a search engine against the publisher's indexed description for each video, or simply by browsing a list of available content sorted e.g. by title or date (preferably with interactive control over such sort criterion, such as by clicking on the column by which that the viewing user would like to sort). The present invention may employ familiar software security techniques (e.g. password) to allow publishers to protect their portal pages for access only by approved viewers (such as paid subscribers for business content, or invited family/guests for personal content) and/or to selectively limit access to certain private items of video content.

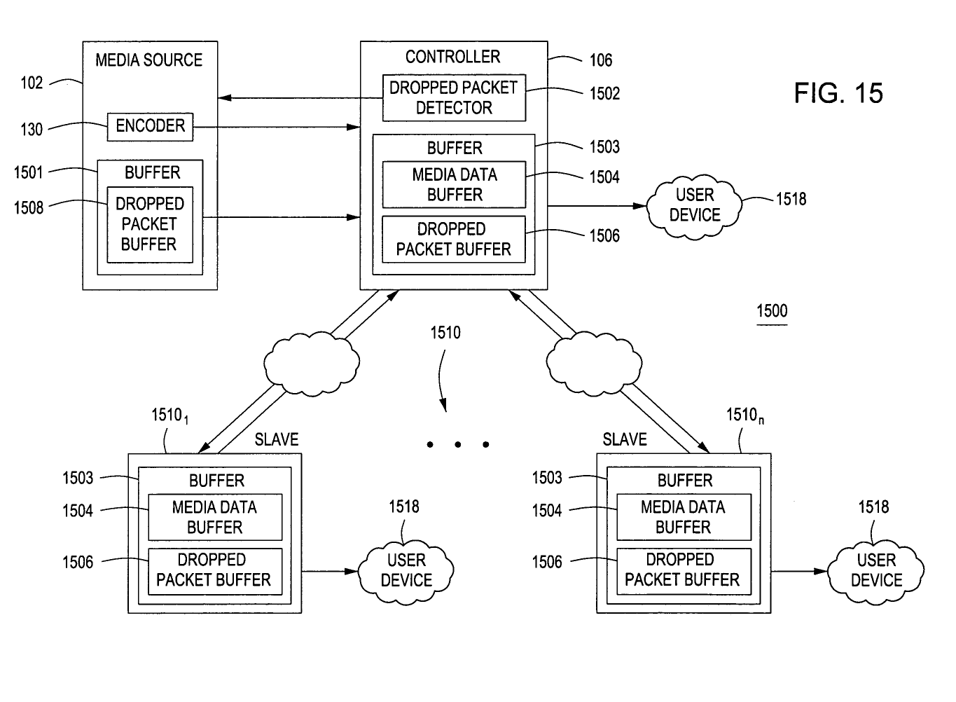

FIG. 15 is a block diagram of one embodiment of a dropped packets handling system 1500 that operates in accordance with the present invention. The dropped packets handling system 1500 comprises a media source 102, a controller 106, slave servers 1510₁ . . . 1510ₙ and user devices 1518. The media source 102 comprises an encoder 130 (see FIG. 1) and a buffer 1501. The buffer 1501 comprises dropped packet buffer data 1508. The controller 106 comprises a dropped packet detector 1502 and a buffer 1503. The buffer 1503 comprises media data buffer 1504 and dropped packet buffer 1506.

As described above, the encoder 130 encodes media data according to the encoding requirements described by the controller 106. The controller 106 (see FIG. 1) receives the encoded media data from the media source 102 and archives the encoded media data in the media data buffer 1504. If the media data is incomplete, the dropped packet detector 1502 detects that media data packets were dropped. The dropped packet detector 1502 analyzes which packets of the encoded media data were dropped. The dropped packet detector 1502 informs the media source 102 of the dropped media data packets.

In one embodiment, the media source 102 archives all media packets in the buffer 1501 for a period of time. When dropped packets are identified, the buffer 1501 maintains the identified dropped packets in the dropped packets buffer 1508. Subsequently, the dropped packets are removed from the dropped packet buffer 1508 and transmitted to the controller 106. In one embodiment, the dropped packet transmission occurs after the completion of the encoding of the media data. In another embodiment, the media source 102 immediately transmits the dropped packet to the controller 106. The controller 106 archives the dropped packets in the dropped packet buffer 1506. The controller 106 then uses the dropped packets to repair the encoded media data such that an accurate file is created. The controller 106 distributes the complete encoded media data to the user device 1518.

In another embodiment, the distribution of media data is performed by a network of servers, i.e., the controller 166 as well as a plurality of slave servers 1510₁ . . . 1510ₙ. In such media distribution system, the controller 106 may either repair the media data using the dropped packets, then the controller 106 may send the media data to the slave server 1510; or the controller 106 may send the erroneous media data along with the dropped packets such that the slave servers 1510 performs the repair functions. In one embodiment, the controller 106 transmits the media data in the media data buffer 1504 and the dropped packets in the dropped packet buffer 1506 to the slave server 1510₁, slave 1510₂ or both. In such case, the slave server 1510 appends the media data and dropped packet and distribute the complete encoded media data to user device 1518. Even though this embodiment shows slave servers 1510₁ . . . 1510ₙ, the system 1500 may include any number of slaves 1510 or may include none.

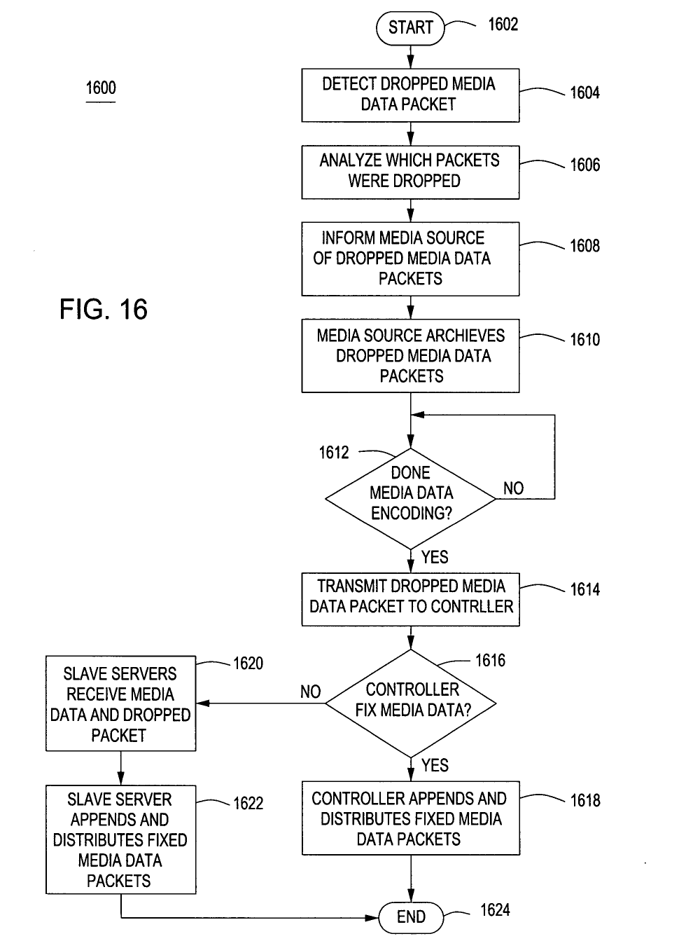

FIG. 16 is a diagram depicting an embodiment of a method 1600 for handling dropped media data packet in accordance with the present invention. The method 1600 starts at step 1602 and proceeds to step 1604. At step 1604, dropped media data packet is detected. At step 1606, the media data is analyzed to detect which media data packet was dropped. At step 1608, the media source is informed that a media data packet was dropped. At step 1610, the media source archives the dropped media data packet. At step 1612, the method 1600 awaits for the media data encoding to finish. Once the media data encoding finishes, the method 1600 proceeds to step 1614. At step 1614, the dropped media data packet in transmitted to the controller. At step 1616, the method 1600 queries if the controller is to fix the media data. If the controller is to fix the media data, the method 1600 proceeds to step 1618; otherwise, the method 1600 proceeds to step 1620. At step 1618, the controller appends the dropped packet to the erroneous media data and transmits the accurate media data to user devices. At step 1620, a slave server(s) receives the erroneous media data and the dropped media packet. At step 1622, the slave server(s) appends the dropped packets to the erroneous media data and transmits the accurate media data to user devices. The method 1600 proceeds from step 1618 and 1622 to step 1624. The method 1600 ends at step 1624.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. An apparatus, comprising:
a controller for distributing encoded media data to third party users, wherein the encoded media data is encoded in response to a control signal generated by the controller in collaboration with a media source.

2. The apparatus of claim 1, wherein the control signal comprises encoding parameters and the controller analyzes environmental characteristics for encoding and distributing the media data and specifies the encoding parameters in response to specific environmental characteristics.

3. The apparatus of claim 1, wherein the control signal comprises information relating to dropped packets of the encoded media data.

4. The apparatus of claim 1 further comprising a remotely located media source for receiving the encoding control signal and dynamically adapting encoding of the media data using the encoding parameters.

5. The apparatus of claim 1 further comprising a media source comprising the controller for receiving the encoding control signal and for dynamically adapting encoding parameters for the encoding media data.

6. The apparatus of claim 1, wherein the controller distributes at least a portion of encoded media data from at least one media source to at least one user device.

7. The apparatus of claim 6, wherein the controller is able to do at least one of distributing the encoded media data at the same time as the controller receives the encoded media data from the media source, archiving at least a portion of the encoded media data, or archiving at least a portion of the encoded media data at the same time as the controller receives the encoded media data.

8. The apparatus of claim 1, further comprising a user interface for facilitating transactions with the controller.

9. The apparatus of claim 1, wherein the encoded media data is at least one of a video data, an audio data, or a photograph data.

10. The apparatus of claim 1, wherein the media source streams media data, as it is encoded, from the local device to the controller.

11. The apparatus of claim 1, wherein the controller identifies dropped packets from the encoded media data received from a media source, and wherein the controller informs the media source of the dropped packets.

12. The apparatus of claim 11, wherein the media source stores a copy of the identified dropped packets and transmits the stored dropped packets to the controller.

13. The apparatus of claim 12, wherein the controller incorporates the re-transmitted dropped packets with the media data initially received without delaying the receipt or the distribution of media data.

14. The apparatus of claim 1, wherein the encoding of media data further includes storing a current portion of media data at the media source during the encoding, and selectively storing the identified media data packets while allowing at least one of the other media data packets to be discarded.

15. The apparatus of claim 1, wherein the controller comprises a plurality of servers.

16. A method for generating encoded media data, comprising:
analyzing at least one of encoding or distribution environment to generate encoding parameters;
generating a control signal through collaboration between a controller and a media source;
controlling encoding of media data in accordance with the encoding control signal; and
distributing the encoded media data to third party users through at least one network.

17. The method of claim 16, wherein the control signal comprises encoding parameters and the controller analyzes environmental characteristics for encoding and distributing the media data and specifies the encoding parameters in response to specific environmental characteristics.

18. The method of claim 16, wherein the control signal comprises a request for dropped packets of the encoded media data.

19. The method of claim 16 further comprising receiving the encoding control signal at remotely located media source.

20. The method of claim 16, wherein the generating step automatically adapts the encoding of the media data according to the encoding control signal.

21. The method of claim 16, wherein the step of analyzing comprises repeatedly analyzing at least one of encoding or distribution environment.

22. The method of claim 21, wherein the repeated analysis dynamically adapts the encoding parameters to at least one of a changing encoding environment or changing distribution environment.

23. The method of claim 16 further comprising at least one of distributing the encoded media data to user devices, distributing the encoded media data at the same time as receiving the encoded media data, archiving at least a portion of the encoded media data, or archiving at least a portion of the encoded media data at the same time as receiving the encoded media data.

24. The method of claim 16, wherein the analyzing step analyzes at least one of media source capabilities or user device capabilities.

25. The method of claim 16, wherein the analyzing step analyzes at least one bandwidth, bitrate, framerate, audio frequency, encoding resolution, or the media source computer power for the controlling of the encoding of media data.

26. The method of claim 16, wherein the encoded media data is at least one of a video data, an audio data, or a photograph data.

27. The method of claim 16, wherein the controller identifies dropped packets from the encoded media data received from a media source, and wherein the controller informs the media source of the dropped packets.

28. The method of claim 27, wherein the media source stores a copy of the identified dropped packets and transmits the stored dropped packets to the controller.

29. The method of claim 28, wherein the controller incorporates the re-transmitted dropped packets with the media data initially received without delaying the receipt or the distribution of media data.

30. The method of claim 16, wherein the encoding of media data further includes storing a current portion of media data at the media source during the encoding, and selectively storing the identified media data packets while allowing at least one of the other media data packets to be discarded.

31. The method of claim 16 wherein the controlling step further comprises selecting a codec.

32. An encoding system for the encoding of media data, comprising:
a controller for analyzing at least one of encoding or distribution environment to generate encoding parameters and for generating an encoding control signal comprising the encoding parameters, wherein the controller distributes the encoded media;
a media source for receiving the encoding control signal and for encoding media data according to the encoding parameters of the encoding control signal generated by the controller; and
third party user device for receiving the encoded media data distributed by the controller through at least one network.
